(19) United States
(12) Patent Application Publication
(10) Pub. No.: US 2005/0052873 A1
(43) Pub. Date: Mar. 10, 2005

(54) Illuminator

(76) Inventor: Kirill Sokolov, Suwon-si (KR)

Correspondence Address: STANZIONE & KIM, LLP, 1740 N STREET, N.W., FIRST FLOOR, WASHINGTON, DC, 20036, US

(21) Appl. No.: 10/915,417

(22) Filed: Aug. 11, 2004

Related U.S. Application Data
(60) Provisional application No. 60/500,688, filed on Sep. 8, 2003.

(30) Foreign Application Priority Data
Nov. 19, 2003 (KR) 2003-82337

(51) Int. Cl. F21V 23/04

(52) U.S. Cl. 362/341

(57) ABSTRACT

An illuminator in which etendue of collected light emitted from a light source can be dynamically controlled. The illuminator includes a light source generating and emitting light, a concave reflector reflecting the light in a predetermined direction, and a retro-reflector placed in the path of the light reflected by the concave reflector. The retro-reflector has an aperture transmitting some of the light and a specular surface reflecting the rest of the light toward the concave reflector.

### CROSS-REFERENCE TO RELATED APPLICATIONS

This application claims the priority of Provisional Patent Application No. 60/500,688, filed on Sep. 8, 2003, in the United States Patent and Trademark Office, and the priority of Korean Patent Application No. 2003-82337, filed on Nov. 19, 2003, in the Korean Intellectual Property Office, the disclosure of which is incorporated herein in its entirety by reference.

### BACKGROUND OF THE INVENTION

1. Field of the Invention

The present general inventive concept relates to an illuminator emitting light generated by a light source in one direction, and more particularly, to an illuminator in which an etendue of light emitted from a light source can be dynamically controlled.

2. Description of the Related Art

Typically, an illuminator is widely used as a light source of an image projection apparatus forming an image by using an image forming device, such as a liquid crystal display device or a digital micro-mirror device, which have no ability to emit light themselves.

To achieve maximum light efficiency in an image projection apparatus, an etendue of a light source must be less than or equal to the etendue limit of an image forming device. Otherwise, the etendue of the light source and that of the image forming device will be unmatched and light loss will occur. Here the etendue represents a geometrical property of an optic device related to beam divergence and the cross-sectional size of a beam. The smaller the etendue, the higher the optical density and the better the brightness.

A general illuminator, comprising a light source generating light and a reflector reflecting the light in one direction, has a predetermined value of etendue. The etendue can be easily calculated by multiplying the cross-sectional area of the beam by the solid angle of the beam at a target in which the beam is received. For example, when an elliptical reflector having a first focal point and a second focal point is employed as a reflector and a light source is placed at the first focal point, the etendue can be calculated by measuring and then multiplying the cross-sectional area and the solid angle of the beam at the second focal point.

General illuminators having the structures illustrated in FIG. 1 through FIG. 3 have low etendue.

Referring to FIG. 1, a general illuminator comprises an ellipsoidal reflector 11 having a first focal point f₁ and a second focal point f₂, a light source 12 placed at the first focal point f₁ of the ellipsoidal reflector 11, and a retro-reflector 15 placed face-to-face with the ellipsoidal reflector 11. The light source 12 is interposed between the retro-reflector 15 and the ellipsoidal reflector 11. The retro-reflector 15 is spherical. An aperture 15a through which an incident beam is transmitted is formed in the center of the retro-reflector 15.

About half of the beam 14 emitted from the light source 12 (solid line) is projected directly onto the elliptical reflector 11, and part of the beam 16 (dotted line) is projected onto the retro-reflector 15. The beam 16, projected directly onto the elliptical reflector 11, is reflected at a specular surface 11a, passes through the aperture 15a, and is focused at the second focus point f₂. On the other hand, the beam projected onto the retro-reflector 15 is reflected back toward the light source 12, passes through the light source 12, and proceeds towards to the elliptical reflector 11. The reflected beam 16 is reflected at the elliptical reflector 11, passes through the aperture 15a, and is focused at the second focus point f₂.

However in an illuminator having such a structure, a collection angle θ of the elliptical reflector 11 is about 90°, which is about 30° less than a collection angle 120° of an illuminator without the retro-reflector 15, thus reducing a solid angle σ, and hence reducing the etendue.

In an illuminator having the above-described structure, the additional retro-reflector 15 increases manufacturing costs and furthermore complicates the manufacturing process required for a proper alignment of the retro-reflector. Moreover, it is difficult to dynamically control the etendue because the size of an aperture is fixed. Also, about half of the total light emitted from a light source will be projected back to the light source, thus reducing the life span of the light source.

FIG. 2 shows another general illuminator, comprising a parabolic reflector 21 having one focal point, a light source 22 placed at the focal point of the parabolic reflector 21, and a retro-reflector 25 placed face-to-face with part of the parabolic reflector 21. The light source 22 is interposed between the retro-reflector 25 and the parabolic reflector 21. The retro-reflector 25 is formed on one side of the optical axis of the system. The parabolic reflector 21 is disposed so that the collection angle θ is 120°.

The parabolic reflector 21 reflects the portion of the beam projected into the range of the collection angle θ. About half of a reflected beam 24 (solid line) is directly projected onto a target 23.

The rest of the beam 26 (dotted line) is projected onto the retro-reflector 25. This beam is reflected back to the parabolic reflector 21. The beam reflected back passes the light source 22 and continues towards the other specular surface of the parabolic reflector 21. Then, this beam proceeds towards the target 23 along the same path as the beam 24.

In an illuminator having such a structure, it is possible to decrease the cross-sectional area of the beam projected from the target 23, hence reducing the etendue.

However, in such an illuminator, it is difficult to dynamically control etendue because the size of the retro-reflector is fixed. Also, about half of the total light emitted from the light source will be reflected back to the light source, thus reducing the life span of the light source.

FIG. 3 illustrates still another general illuminator, comprising a parabolic reflector 31 having one focal point, a light source 32 placed at the focal point of the parabolic reflector 31, and a retro-reflector 35 placed face-to-face with a predetermined part of the circumference of the parabolic reflector 31. The light source 32 is interposed between the retro-reflector 35 and the parabolic reflector 31. An aperture 35a, through which a projected beam passes, is formed in the center of the retro-reflector 35. The parabolic reflector 31 has a collection angle θ of 120°.

The parabolic reflector 31 reflects the portion of the beam projected into the range of the collection angle θ. Part of the reflected beam 34 (solid line) heads towards the aperture 35a, passes through the aperture 35a, and is then directly projected onto a target 33.

The rest of the beam 36 (dotted line) is projected onto the retro-reflector 35. This beam is reflected back to the parabolic reflector 31, passes the light source 32, and proceeds towards the other specular surface of the parabolic reflector 31. Then the beam is reflected back and proceeds towards the target 33 along the same path as the beam 34.

In an illuminator having such a structure, it is possible to decrease the cross-sectional area of the beam projected onto the target 33, hence reducing the etendue.

However, in such an illuminator, it is difficult to dynamically control the etendue because the size of the retro-reflector is fixed. Also, about half of the total light emitted from the light source will be reflected back to the light source, thus reducing the life span of the light source.

### SUMMARY OF THE INVENTION

The present general inventive concept provides an illuminator that has low manufacturing costs, a simple assembly process, minimizes effects on a light source, and can dynamically control etendue by varying the size of an aperture.

Additional aspects and advantages of the present general inventive concept will be set forth in part in the description which follows and, in part, will be obvious from the description, or may be learned by practice of the general inventive concept.

According to an aspect of the present general inventive concept, there is provided an illuminator including a light source generating and emitting light, a concave reflector reflecting the light in a predetermined direction, and an aperture placed in the path of the light reflected by the concave reflector. The retro-reflector has an aperture transmitting some of the light and a specular surface reflecting the rest of the light toward the concave reflector.

According to another aspect of the present general inventive concept, there is provided an illuminator further including a variable unit that varies the width of the aperture, thereby dynamically controlling the amount of light reflected back from the specular surface.

According to still another aspect of the present general inventive concept, there is provided an illuminator further including a rod integrator placed in the path of the light reflected by the concave reflector. The rod integrator mixes and emits the light.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a sectional diagram of an illuminator employing a conventional elliptical reflector;

FIG. 2 is a schematic diagram of an illuminator employing a conventional parabolic reflector;

FIG. 3 is a schematic diagram of an illuminator employing another conventional parabolic reflector;

FIG. 4 is a schematic diagram of an illuminator according to an embodiment of the present general inventive concept;

FIG. 5 is a graph illustrating the changes of light flux with respect to the changes in the size of the aperture in the retro-reflector shown in FIG. 4;

FIG. 6 is a schematic diagram of an illuminator according to another embodiment of the present general inventive concept;

FIG. 7 is a perspective view of a rod integrator and a retro-reflector of the illustrator shown in FIG. 6;

FIG. 8 is a sectional view showing another example of the rod integrator shown in FIG. 6; and

FIG. 9 is a schematic of an illuminator according to another embodiment of the present general inventive concept.

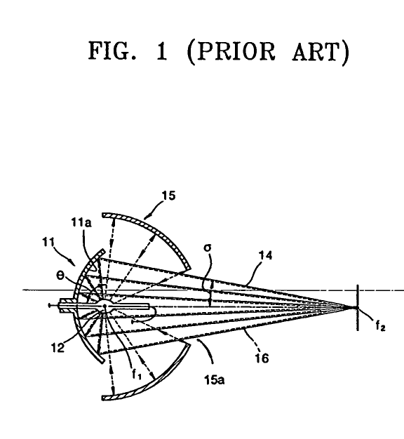

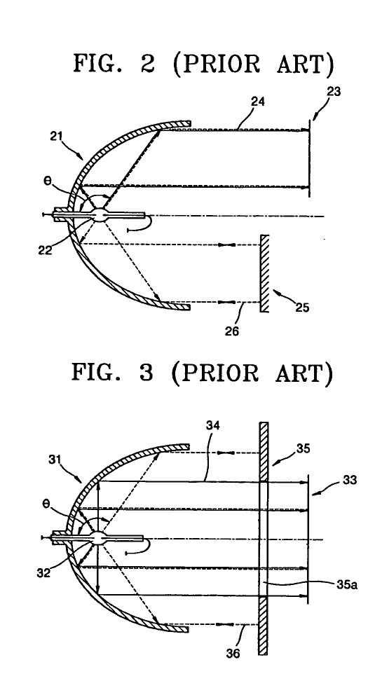

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

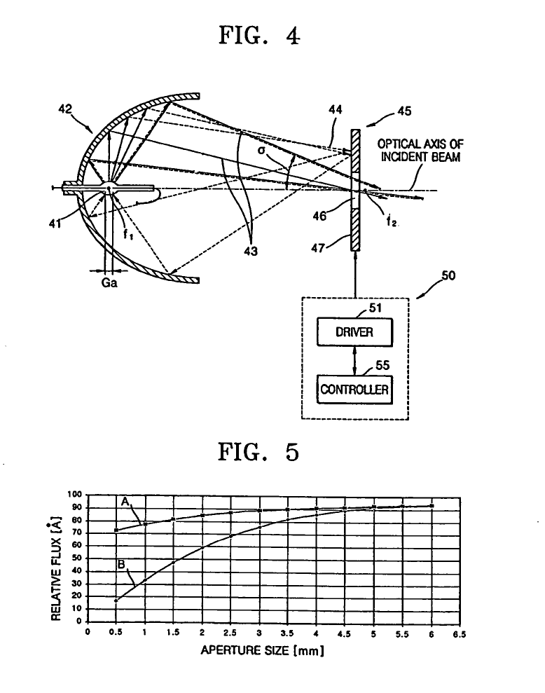

Referring to FIG. 4, an illuminator according to an embodiment of the present general inventive concept includes a light source 41 generating and emitting light, a concave reflector 42 directing the emitted light in a predetermined direction, and a retro-reflector 45 placed face-to-face with the concave reflector 42. The light source 41 is interposed between the retro-reflector 45 and the concave reflector 42. The retro-reflector 45 lies in a path of a beam reflected from the concave reflector 42, has an aperture 46 transmitting part of the beam and a specular surface 47 reflecting back a remaining part of the beam. The specular surface 47 can be flat such that the surface is at a right angle to the optical axis of the concave reflector 42. The aperture 46 has a rectangular or circular shape and is located in the center of the specular surface 47.

The illuminator according to an embodiment of the present general inventive concept may include a variable unit 50 varying the width of the aperture 46. The variable unit 50 may include a driver 51 and a controller 55. The variable unit 50 varies the size of the aperture 46 according to the type of an optical system, for example, a projection apparatus employing the illuminator. In this case, it is possible to dynamically control the beam reflected back from the specular surface 47 by varying the size of the aperture 46.

The concave reflector 42 may be an elliptical reflector having a first focal point f₁ and a second focal point f₂. In this case, the light source 41 is placed at the first focal point f₁ and the beam emitted from the light source 41 is reflected at the concave reflector and focused at the second focal point f₂. The retro-reflector 45 is placed at the second focal point f₂.

The light source 41 may be an arc lamp generating light by arc discharging. The arc lamp can be one of a metal-halide lamp, a xenon lamp, etc.

The arc gap (Ga) preferably meets the condition of Equation 1.
0.7≦Ga≦3[mm] (1)

Hereinafter, movement of the illuminator according to an embodiment of the present general inventive concept will be described in detail.

Most of the beam emitted from the light source 41 is projected directly onto the concave reflector 42 and reflected to the second focal point f₂. The beam is not generated from the point light source but from the arc gap in the light source 41. Therefore, even when an elliptical reflector is used for the concave reflector 42, the reflected beam doesn't proceed wholly towards the second focal point f₂ but disperses widely around the second focal point f₂ as illustrated.

Part of the reflected beam 43 (solid line) is directly projected into the aperture 46. The rest of the beam 44 (dotted line) is projected onto the specular surface 47 and reflected back to the concave reflector 42. The beam is then reflected by the concave reflector 42 toward the retro-reflector 45 along a different path. Then, part of the beam is transmitted through the aperture 46 and the rest of the beam is reflected by the specular surface 47. Almost the entire beam reflected by the concave reflector 42 is transmitted through the aperture 46 by repeating the reflecting processes.

It is possible to dynamically control the size of the aperture 46 with the variable unit 50. Thus, it is also possible to control the solid angle σ of the beam transmitted through the aperture 46. Since the solid angle σ is inversely proportional to the amount of the beam reflected back by the retro-reflector 45, it is possible to reduce the amount of the beam reflected towards the light source 41.

Therefore, the illuminator according to an embodiment of the present general inventive concept can reduce the load of the light source 41 and prevent the life span of the light source 41 from being shortened. Furthermore, the illuminator can be used in projection systems requiring less etendue, for example, a projection system displaying color images with a color wheel.

FIG. 5 is a graph illustrating the light flux with respect to the size of the aperture in the retro-reflector shown in FIG. 4. Here, a line A illustrates a case where the illuminator has an aperture and a specular surface. A line B refers to a change of light flux when the illuminator has a surface absorbing the projected beam instead of the specular surface.

As shown in FIG. 5, relative change of light flux is small in the illuminator according to an embodiment of the present general inventive concept having a specular surface even if the size of the aperture is small. On the other hand, in a general illuminator having an absorbing surface (not shown) when the aperture is small, light flux is very small, and when the aperture is large, the light flux is about the same as that of the illuminator according to an embodiment of the present general inventive concept.

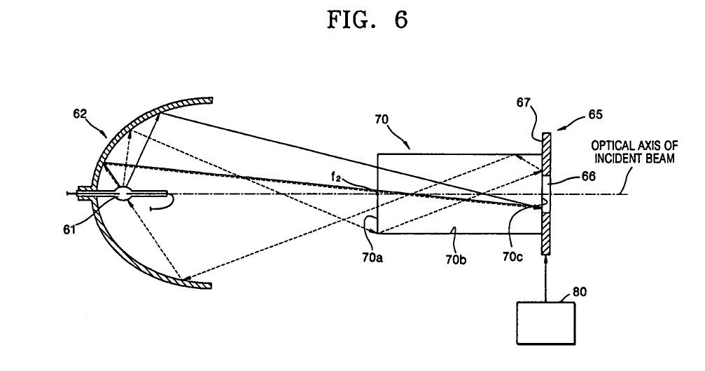

Referring to FIG. 6, an illuminator according to another embodiment of the present general inventive concept includes a light source 61 generating and emitting light, a concave reflector 62 directing the emitted light in a predetermined direction, and a retro-reflector 65 and a rod integrator 70 placed face-to-face with the concave reflector 62. The light source 61 and the rod integrator 70 are interposed between the retro-reflector 65 and the concave reflector 62. The illuminator also includes a variable unit 80 varying the width of an aperture 66 of the retro-reflector 65.

The illuminator of the present embodiment differs from the illuminator of the previous embodiment in that the illuminator of the present embodiment includes the rod integrator 70. The other components of the illuminator of the present embodiment including the light source 61, the concave reflector 62, and the retro-reflector 65, are the same as those described with reference to FIG. 4.

The rod integrator 70 is disposed in the path of the beam reflected from the concave reflector 62, making the beam uniform by mixing rays of the beam. The rod integrator 70 may include an input end 70a, a specular plane 70b reflecting and guiding the beam transmitted through the input end 70a, and an output end 70c emitting the beam reflected and mixed in the specular plane 70b.

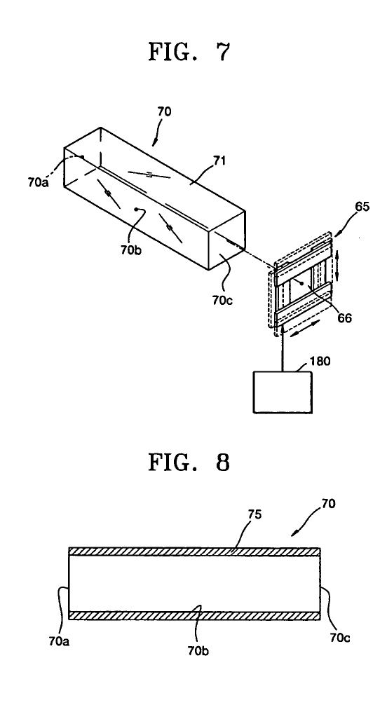

The rod integrator 70 may be a rod 71 having a rectangular shape, as shown in FIG. 7. The rod 71 may be composed of glass or plastic having a higher index of refraction than its surroundings. Therefore, the beam transmitted through the input end 70a proceeds towards the output end 70c and is totally reflected by the specular plane 70b due to the relationship between the incidence angle and the indexes of refraction of the rod 71 and the external environment. Through this process, the uneven beam projected from the light source 61 is totally reflected and mixed back within the rod integrator 70, resulting in a uniform beam.

Also, the rod integrator 70 may include a hollow tube 75 and a specular plane 70b disposed on the inner wall of the hollow tube 75, as shown in FIG. 8. The beam transmitted through the input end 70a is reflected by the specular plane 70b and proceeds inside, and becomes a uniform beam.

Referring to FIG. 6, the retro-reflector 65 is placed face-to-face with the output end 70c of the rod integrator 70 and controls the emitted beam. The size of the aperture 66 is smaller than that of the output end 70c. Therefore, part of the beam emitted from the output end 70c is reflected from the specular surface 67, passes through the rod integrator 70, and proceeds towards the concave reflector 62. The other part of the beam is transmitted through the aperture 66. By repeating this process of reflecting, almost the entire beam emitted from the light source 61 and reflected by the concave reflector 62 is transmitted through the aperture 66.

In the illuminator according to the present embodiment including the rod integrator 70, it is possible to make the beam emitted from the light source 61 uniform and also control the solid angle of the beam transmitted through the aperture 66.

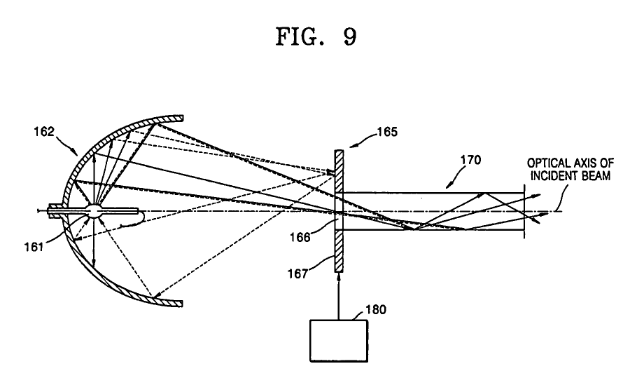

Referring to FIG. 9, an illuminator according to still another embodiment of the present general inventive concept includes a light source 161 generating and emitting light, a concave reflector 162 directing the emitted light in a predetermined direction, a retro-reflector 165 having an aperture 166 and a specular surface 167, and a rod integrator 170. The light source 161 is interposed between the retro-reflector 165 and the concave reflector 162. The retro-reflector 165 is disposed at an end of the rod integrator 170. The illuminator also includes a variable unit 180 varying the width of the aperture 166.

The illuminator of the present embodiment differs from the illuminator of the previous embodiment in the arrangement of the rod integrator 170. The remaining components of the illuminator, including the light source 161, the concave reflector 162, the retro-reflector 165, and the variable unit 180 have the same structures and functions as described with reference to FIG. 4 and FIG. 8.

The rod integrator 170 is placed in the path of the beam transmitted through the aperture 166, and mixes the beam, thus making the beam uniform. Here, a portion of the beam that deviates from the input end of the rod integrator 170 is reflected back from the specular surface 167 to the concave reflector 162.

In an illuminator having the above-described structure, it is possible to dynamically control the etendue by varying the size of the aperture of the retro-reflector, thus increasing the optical density of collected light.

Having a large solid angle σ reduces the load of the light source and prevents the life span of the light source from being shortened by reducing the amount of light reflected back to the light source.

The illuminator can be used in projection systems requiring less etendue, for example, a projection system displaying color, images with a color wheel because it is possible to reduce the etendue by reducing the solid angle.

The illuminator with the rod integrator can emit a uniform beam of which the etendue is reduced. The structure of such an illuminator is compact, thus lowering the manufacturing cost and simplifying a process of manufacturing.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An illuminator comprising:
a light source emitting light;
a concave reflector reflecting the light emitted from the light source in a predetermined direction;
a retro-reflector having a specular surface reflecting the light back toward the concave reflector, and having an aperture disposed at a focal point of the light reflected by the concave reflector, the aperture transmitting part of the reflected light.

2. The illuminator of claim 1, wherein the concave reflector is an elliptical reflector having a first focal point and a second focal point, the light source is placed approximately at the first focal point, and the retro reflector is placed approximately at the second focal point.

3. The illuminator of claim 1, further comprising a variable unit that dynamically controls the light reflected from the specular surface by varying a size of the aperture.

4. The illuminator of claim 1, wherein the specular surface is disposed at a right angle to the optical axis of the concave reflector and the aperture of the specular surface has a rectangular or circular shape.

5. The illuminator of claim 1, wherein the light source is an arc lamp generating light by arc discharging.

6. The illuminator of claim 5, wherein an arc gap (Ga) of the arc lamp meets the condition of the following equation:
0.7≦Ga≦3[mm]

7. The illuminator of claim 1, further comprising a rod integrator disposed in the path of the light reflected by the concave reflector, the rod integrator mixes and emits the light.

8. The illuminator of claim 7, wherein the retro-reflector is disposed at an output end of the rod integrator and part of the light projected through the rod integrator can be reflected back toward the concave reflector.

9. The illuminator of claim 7, wherein the retro-reflector is disposed at an input end of the rod integrator and a portion of the light that deviates from the input end of the rod integrator can be reflected back to the concave reflector.

10. The illuminator of claim 7, wherein the rod integrator comprises a rectangular rod composed of glass or plastic and the projected light can be wholly reflected back into the rod integrator from sides of the rod integrator due to the difference between the index of refraction of the rectangular rod and the surrounding environment.

11. The illuminator of claim 7, wherein the rod integrator comprises a hollow tube and a specular plane formed on an inner wall of the hollow tube and the projected light is reflected by the specular plane and proceeds back inside the tube to provide a uniform light.

12. An illuminator comprising:
a light source emitting light;
a first reflector reflecting the light emitted from the light source in a predetermined direction; and
a second reflector including:
a surface reflecting the light back toward the concave reflector, and
a variable aperture disposed at a focal point of the light reflected by the concave reflector to transmit part of the reflected light.

13. The illuminator of claim 12, wherein the first reflector is an elliptical reflector having a first focal point and a second focal point, the light source is placed approximately at the first focal point, the elliptical reflector collects the light reflected from the second reflector surface, and the second reflector is placed at and surrounds the second focal point.

14. The illuminator of claim 12, further comprising a variable unit that dynamically controls the light reflected from the second reflector surface by varying a size of the aperture.

15. The illuminator of claim 12, wherein the surface of the second reflector is disposed at a right angle to the optical axis of the first reflector and the aperture of the second reflector surface has a rectangular or circular shape.

16. The illuminator of claim 12, wherein the light source is an arc lamp generating light by arc discharging.

17. The illuminator of claim 16, wherein an arc gap (Ga) of the arc lamp meets the condition of the following equation:
0.7≦Ga≦3[mm]

18. The illuminator of claim 12, further comprising a rod integrator disposed in the path of the light reflected by the first reflector, the rod integrator collects and emits the light.

19. The illuminator of claim 18, wherein the second reflector is disposed at an output end of the rod integrator and part of the light projected through the rod integrator can be reflected back toward the first reflector.

20. The illuminator of claim 18, wherein the second reflector is disposed at an input end of the rod integrator and a portion of the light that deviates from the input end of the rod integrator can be reflected back to the first reflector.

21. The illuminator of claim 18, wherein the rod integrator comprises a rectangular rod composed of glass or plastic and the projected light can be wholly reflected back into the rod integrator from sides of the rod integrator due to a difference between the index of refraction of the rectangular rod and a surrounding environment.

22. The illuminator of claim 18, wherein the rod integrator comprises a hollow tube and a reflective plane formed on inner walls of the hollow tube, and rays of the light contacting the reflective planes are reflected back inside the tube to provide a uniform light emitted through the hollow tube.

23. A method of illuminating light, comprising:
emitting light toward a concave reflector that reflects the light in a predetermined direction towards a focal point;
reflecting portions of the light reflected from the concave reflector which is not projected within a predetermined circumferential area located at the focal point of the concave reflector back towards the concave reflector while transmitting the light reflected from the concave reflector which is projected within the predetermined circumferential area located at the focal point of the concave reflector.

24. The method of claim 23, further comprising:
controlling the light reflected back toward the concave reflector by varying the size of the predetermined circumferential area.
